(19) United States
(12) Patent Application Publication
(10) Pub. No.: US 2010/0166347 A1
(43) Pub. Date: Jul. 1, 2010

(54) COOLED THIN-SHELL BEARING BUSHING

(75) Inventor: Michel Wendling, Strasbourg (FR)

Correspondence Address: OLIFF & BERRIDGE, PLC, P.O. BOX 320850, ALEXANDRIA, VA, 22320-4850, US

(73) Assignee: FLENDER GRAFFENSTADEN S.A.S., ILLKIRCH (FR)

(21) Appl. No.: 12/451,664

(22) PCT Filed: May 23, 2008
(86) PCT No.: PCT/FR2008/050896

§ 371 Date: Dec. 15, 2009

(30) Foreign Application Priority Data
May 24, 2007 (FR) 0703689

(51) Int. Cl. F16C 32/06; F16C 37/00

(52) U.S. Cl. 384/114

(57) ABSTRACT

Cooling system for a hydrodynamic bearing bushing of annular appearance positioned in a support body, equipped with means of distributing cold oil under pressure to a shaft rotating in the bearing bushing, wherein it consists of a thin annular shell, the external surface of which is closely fitted into the bore of said support body, grooves being made in that part of said bore that corresponds to the angular region of the bearing bushing on which the load is applied during operation, said grooves being supplied with cold oil tapped downstream from the distribution means.

The invention relates to a hydrodynamic bearing bushing, with fixed lobes or cylindrical, capable of being used in applications with strong radial load and high shaft speeds. It more particularly relates to a system for cooling such bearing bushings.

The aforementioned conditions are notably encountered in the case of pinion shaft bearing bushings of speed reducers or increasers with high power gears, for example on turbine engines. In these applications, the bearing bushings are provided with means for distributing cold oil under pressure, for purposes of lubricating and cooling components in contact.

The dimensioning of the hydrodynamic bearing bushings intended for these applications is moreover carried out so that it is not possible to have the gliding surface of said bearing bushings work beyond an imposed pressure limit. This limitation is in particular intended for preserving a safety coefficient in the mechanical fatigue strength of the antifriction material forming the sliding surface of the bearing bushing.

Under the assumption of significant radial forces exerted by the rotary shaft, the aforementioned limiting pressure condition forces selection of large silk diameters. This may lead to operating the bearing bushing at high silk speeds. Under these operating conditions, the lamination of the oil injected between the bearing bushing and the shaft which results from this high speed leads to significant generation of calories in the maximum speed gradient area in the oil film between the shaft and the antifriction material of the bearing bushing.

One part of these calories are removed by convection by the oil flow rate through the bearing bushing. Another part is transmitted by conduction in the shaft and in the body of the bearing bushing.

Observation of the distribution of the temperatures in the oil film of a hydrodynamic bearing bushing of standard design shows that the highest temperatures are located in a reduced angular region ranging from the angular position of the load up to the exit of the fixed lobe. The areas of the bearing bushing outside the loading area remain at lower temperatures, i.e. closer to the pressure injection temperature of the “cold” oil in the bearing bushing.

The heat flow transmitted by conduction of the oil film towards the body of the bearing bushing is very high in the angular loading region. The distribution of the temperatures in said film is established according to the removed local heat flow, which notably depends on the heat resistance between the minimum film area of the bearing bushing and the cold temperature at the limits of the bearing support.

The main goal of the present invention is to control and reduce the temperature in the oil film by reducing the heat conduction resistance in the body of the bearing bushing.

For this purpose, the cooling system of the invention, being applied to a hydrodynamic bearing bushing with an annular appearance positioned in a support body, and provided with means for distributing cold oil under pressure towards a rotating shaft in the bearing bushing, is mainly characterized in that it consists of a thin annular shell, the external surface of which is closely fitted into the bore of the support body, grooves being made in said bore, said grooves being supplied with cold oil tapped downstream from the distribution means.

This network of grooves enables oil to circulate on the back of the thin shell. Oil tapped on the cold oil distribution system at the entrance of the support body of the bearing bushing runs along the grooves. With the flow in the network of grooves, part of the calories produced by the lamination of the oil in the minimum film area of the bearing bushing may be removed, calories which are then transmitted by conduction through the thin wall of the shell.

The configuration of the network of grooves, which allows a certain flow rate and controls the distribution of cold oil, of course, plays an important role for obtaining the sought result.

Thus, according to one possibility, the grooves are made in the support body as a network of axial grooves.

Alternatively, the network may appear as circumferential grooves. According to still another configuration, the network may be formed by helicoidal grooves.

Generally, this oil flow circulates in the network, and then exits from each side of the body in which the shell is placed and is finally discharged by gravity into a case containing said bearing bushing.

By means of the heat convection ensured by the oil flow, the temperature on the back of the shell is reduced, which causes global lowering of the temperatures inside the thin shell, and in particular of the highest temperatures located in the angular film area of minimum thickness.

The sought reduction in temperature may be of variable extent, depending on the applications and according to the oil flow rate for cooling the body.

For a moderate temperature reduction, the use of a thin shell in stainless steel as base material is sufficient.

Under an assumption of more critical operating conditions of the bearing bushing as regards speed and load, it is possible to use a metal shell with high heat conductivity, for example an alloy based on copper. By means of the closely-fitted assembly mode of the shell in a massive stainless steel body, the large radial forces exerted by the silks of the shafts may actually be withstood by a bearing bushing in such an alloy without any risk of burring the outer supporting surfaces of the shell.

In a perspective of removing heat also for ensuring proper mechanical strength according to the invention, the support body of the thin bearing bushing may be made in stainless steel.

The invention will now be described in more detail, with reference to an example illustrated by the following figures corresponding to the case of axial grooves:

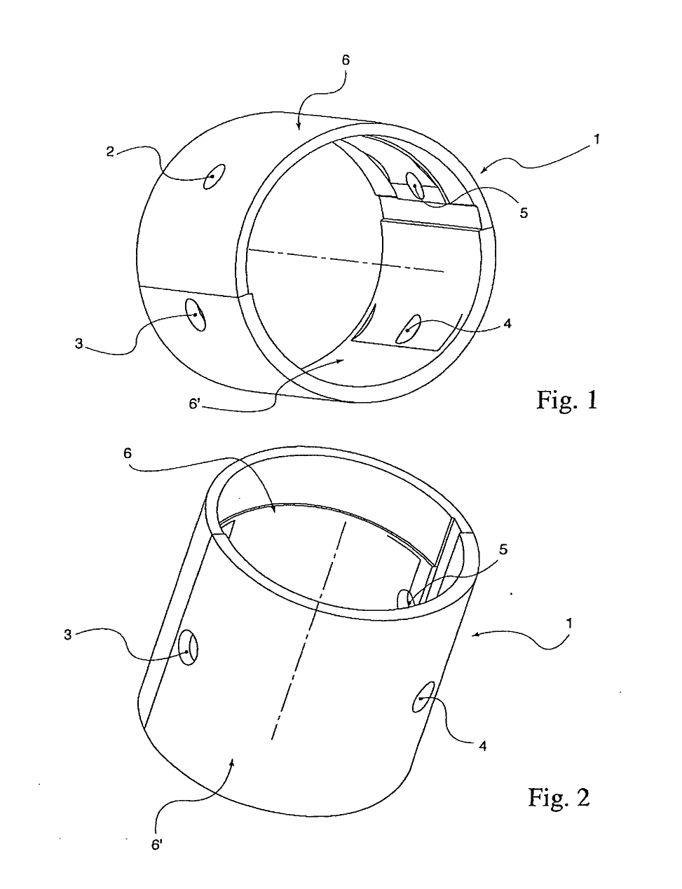

FIG. 1 is a perspective view of the bearing bushing according to the invention;

FIG. 2 illustrates, still in a perspective view, the same bearing bushing according to another orientation;

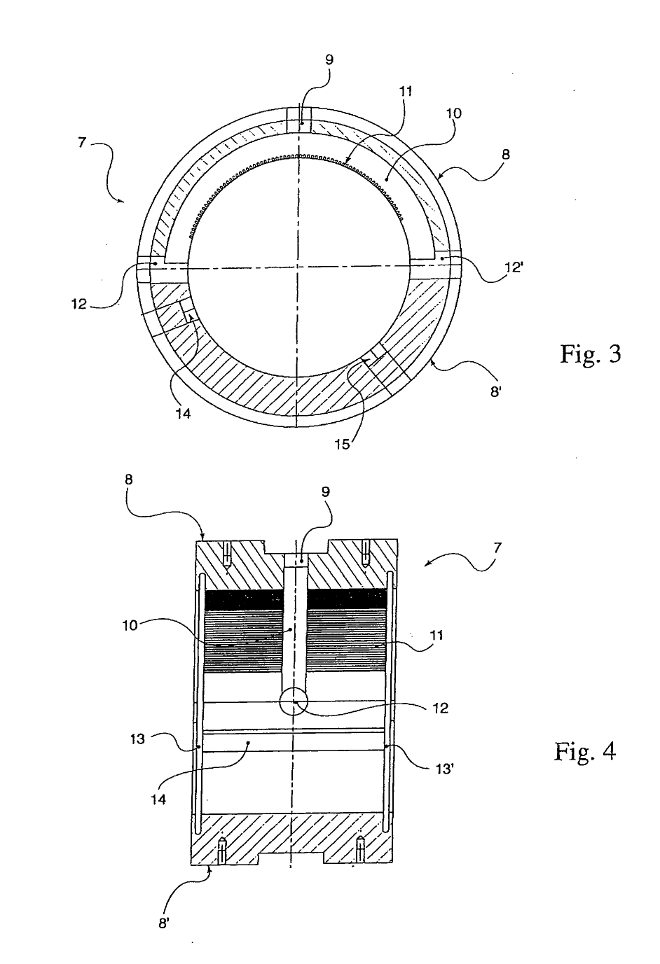

FIG. 3 is a transverse sectional view of a support body in which the bearing bushing shown in the previous figures is mounted without any play; and

FIG. 4 shows a longitudinal section of the same support body.

With reference to FIGS. 1 and 2, the bearing bushing is formed with a thin annular shell (1) in this case having four dissymmetrical lobes, and provided with orifices (2, 3, 4, 5) for letting through lubricating oil towards the rotary shaft. However, the invention, of course, applies to other types of bearing bushings, for example simple cylindrical bearing bushings.

According to the invention, this thin shell (1) is formed with two half-shells (6, 6′) which are intended to be closely fitted into a support body (7) itself consisting of two semi-cylindrical portions (8, 8′) firmly secured for example by cottering, and which appears in FIGS. 3 and 4.

The oil intended to cool the shell and to lubricate the rotary shaft arrives through the orifice (9) and is distributed via a semi-circumferential flute (10) towards a network of axial grooves (11). This network of grooves (11) is made in the portion (8) of the support body (7) which in practice corresponds to the half-shell (6) containing the loading lobe(s), the most critical in terms of cooling. The flute (10) moreover allows direct feeding of the orifices (2 and 5) of the half-shell (6).

The lubricant oil is also distributed, via axial channels (14, 15) to the orifices (3, 4). These axial channels (14, 15) are fed at the outlet of the grooves (11) by peripheral flutes (13, 13′). Side orifices (12, 12′) finally allow discharge of the oil by gravity into a case (not shown).

The means for distributing cold oil under pressure are not illustrated and feed the system via the orifice (9).

Therefore, it appears clearly that the grooves (11) are actually positioned immediately downstream from these means, i.e. before having been subject to a significant rise in temperature. The groove network (11) allows the oil to be properly circulated on the back of the half-shell (6), the one which should remove the highest heat flow since it includes the loading lobe. The flow rate in the groove network (11) allows at least one portion of the calories to be removed, those which are produced by the lamination of oil in the loading area.

The example above of course is not a limitation of the invention, which encompasses alternative configurations for example affecting the network of grooves, as already mentioned: these grooves may be circumferential, helicoidal or other ones. The selected materials, insofar that they fulfill the provided function, may also differ from the examples above.

1. A cooling system for a hydrodynamic bearing bushing of annular appearance positioned in a support body, provided with means for distributing cold oil under pressure towards a shaft rotating in the bearing bushing, wherein it consists of a thin annular shell, the external surface of which is closely fitted into the bore of said support body, grooves being made in a portion of said bore corresponding to the angular region of the bearing bushing on which the load is applied during operation, said grooves being supplied with cold oil tapped downstream from the distribution means.

2. The cooling system for a hydrodynamic bearing bushing according to claim 1, wherein the grooves are made in the support body in the form of a network of axial grooves.

3. The cooling system for a hydrodynamic bearing bushing according to claim 1, wherein the grooves are made in the support body in the form of a network of helicoidal grooves.

4. The cooling system for a hydrodynamic bearing bushing according to claim 3, wherein the shell is in stainless steel.

5. The cooling system for a hydrodynamic bearing bushing according to claim 1, wherein the shell is in a copper-based alloy with high heat conductivity.

6. The cooling system for a hydrodynamic bearing bushing according to claim 1, wherein support body is in stainless steel.

7. The cooling system for a hydrodynamic bearing bushing according to claim 2, wherein the shell is in a copper-based alloy with high heat conductivity.

8. The cooling system for a hydrodynamic bearing bushing according to claim 3, wherein the shell is in a copper-based alloy with high heat conductivity.

9. The cooling system for a hydrodynamic bearing bushing according to claim 2, wherein support body is in stainless steel.

10. The cooling system for a hydrodynamic bearing bushing according to claim 3, wherein support body is in stainless steel.

11. The cooling system for a hydrodynamic bearing bushing according to claim 4, wherein support body is in stainless steel.

12. The cooling system for a hydrodynamic bearing bushing according to claim 5, wherein support body is in stainless steel.

13. The cooling system for a hydrodynamic bearing bushing according to claim 7, wherein support body is in stainless steel.

14. The cooling system for a hydrodynamic bearing bushing according to claim 8, wherein support body is in stainless steel.
